(19) United States
(12) Patent Application Publication
(10) Pub. No.: US 2024/0388328 A1
(43) Pub. Date: Nov. 21, 2024

(54) PRECODING COMBINERS FOR RECONFIGURABLE INTELLIGENT SURFACE (RIS) AIDED COMMUNICATIONS

(71) Applicant: QUALCOMM Incorporated, San Diego, CA (US)

(72) Inventors: Ahmed ELSHAFIE, San Diego, CA (US); Alexandros MANOLAKOS, Athens (GR); Yu ZHANG, San Diego, CA (US); Hung Dinh LY, San Diego, CA (US); Saeid SAHRAEI, San Diego, CA (US)

(21) Appl. No.: 18/695,731

(22) PCT Filed: Nov. 30, 2021
(86) PCT No.: PCT/CN2021/134551

§ 371 Date: Mar. 26, 2024

(51) Int. Cl. H04B 7/04; H04B 7/06; H04L 25/02

(52) U.S. Cl. CPC H04B 7/04026; H04B 7/0639; H04L 25/0224

(57) ABSTRACT

Aspects of the present disclosure provide techniques for configuring RIS components in order to achieve a certain object. According to certain aspects, a first device may participate in a first training procedure to obtain a set of channel estimates corresponding to different paths between a second device and the first device involving reflections from different reconfigurable intelligent surface (RIS) components, participate in a second training procedure, using the set of channel estimates, to obtain a combining vector of coefficients to configure the RIS components based on at least one objective, and communicate with the second device with the RIS components configured according to the combining vector.

### INTRODUCTION

Aspects of the present disclosure relate to wireless communications, and more particularly, to techniques for configuring reconfigurable intelligent surface (RIS) elements.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communications by a first device. The method generally includes participating in a first training procedure to obtain a set of channel estimates corresponding to different paths between the second device and the first device involving reflections from different reconfigurable intelligent surface (RIS) components, participating in a second training procedure, using the set of channel estimates, to obtain a combining vector of coefficients to configure the RIS components based on at least one objective, and communicating with the second device with the RIS components configured according to the combining vector.

One aspect provides a method for wireless communications by a second device. The method generally includes configuring a first device to participate in a first training procedure to obtain a set of channel estimates corresponding to different paths between the second device and the first device involving reflections from different reconfigurable intelligent surface (RIS) components and to participate in a second training procedure, using the set of channel estimates, to obtain a combining vector of coefficients to configure the RIS components based on at least one objective, participating, with the first device, in the first training procedure and the second training procedure, and communicating with the first device with the RIS components configured according to the combining vector.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A-3D depict various example aspects of data structures for a wireless communication network.

FIG. 4A illustrates an example of communication blockage between wireless communication devices.

FIG. 4B illustrates an example of using a RIS to overcome impediment by obstacles between a BS and a UE, according with certain aspects of the present disclosure.

FIG. 5A, 5B, and 5C, illustrate an example of training precoding weights for precoding RIS elements, in accordance with certain aspects of the present disclosure.

FIG. 6 illustrates an example RIS with sub-RIS components, in accordance with certain aspects of the present disclosure.

FIG. 7 illustrates an example communication using a RIS with sub-RIS components, in accordance with certain aspects of the present disclosure.

FIG. 8A, 8B, 8C, and 8D, illustrate an example of a training procedure, in accordance with certain aspects of the present disclosure.

FIG. 9 is a flow diagram illustrating example operations for wireless communication by a second device, according to aspects of the present disclosure.

FIG. 10 is a flow diagram illustrating example operations for wireless communication by a first device, according to aspects of the present disclosure.

FIG. 11 depicts aspects of an example communications device.

FIG. 12 depicts aspects of an example communications device.

### DETAILED DESCRIPTION

Aspects of the present disclosure provide apparatus, methods, processing systems, and computer readable mediums for configuring reconfigurable intelligent surface (RIS) for aiding communications between wireless devices. For example, the wireless devices may include a user equipment (UE) and a network entity (e.g., a base station such as a gNB) or two UEs (e.g., for sidelink communications).

A RIS typically includes an array of metamaterial that may interact with radio signals by tuning the impedance variations over the surface. For example, a RIS controller may configure and reconfigure at least one RIS element (e.g., a small antenna that reflects radio waves with a configurable time delay or phase shift). According to the present disclosure, the RIS controller participates in training, with and between a transmitter and a receiver, by applying different precodings to the RIS elements based on the codebook, while the transmitter transmits reference signals (RSS). The RIS controller receives feedback from the receiver based on the training and applies precoding to the RIS elements for communications between the transmitter and the receiver based on the feedback and the codebook.

At a high level, a RIS includes a number of elements, which form a surface that may be integrated into different objects such as walls, sidings, cloths, etc. The RIS elements are reconfigurable scatterers, including antennas that receive and re-radiate (e.g., reflect or refract) radio wave signals. The RIS elements may be passive, such that no external power is required for the re-radiation, and such that the re-radiation is configurable with a phase shift for each RIS element. The RIS element may also be active, such that the re-radiation may change the amplitude in addition to the phase shift. The RIS elements may therefore perform constructive interference that resembles beamforming and re-radiate beams in certain directions from a transmitter (e.g., a UE) toward a receiver (e.g., a BS). Such beamforming or precoding of the RIS elements is controlled by identifying each phase shift values, or weights, to be applied to each RIS element given specific conditions of the transmitter and the receiver.

Aspects of the present disclosure provides techniques for generating precoding weights that may be used to configured RIS components (e.g., via a RIS controller) in order to provide an efficient or optimized re-radiation. As will be described in greater detail below, various RIS components may be configured in a manner designed to combine reflected signals to enhance a received signal at one UE and/or to cancel out (null) reflected signals to reduce interference at one or more other UEs.

### Introduction to Wireless Communication Networks

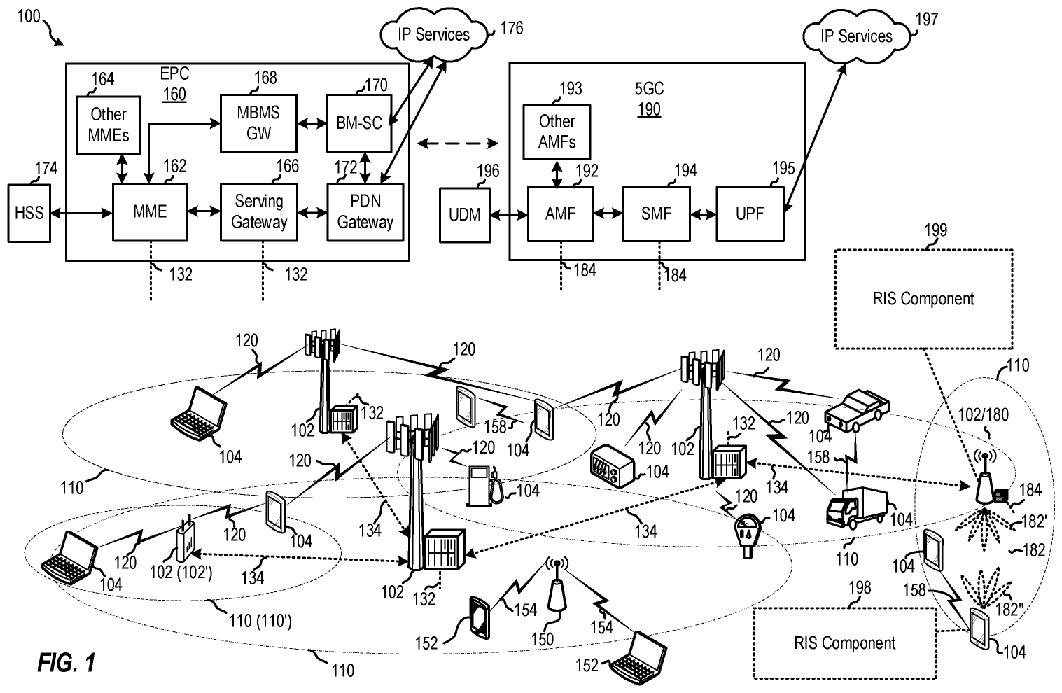

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes RIS Component 199, which may be configured to participate in training of RIS elements. Wireless network 100 further includes RIS Component 198, which may be used configured to participate in training of RIS elements.

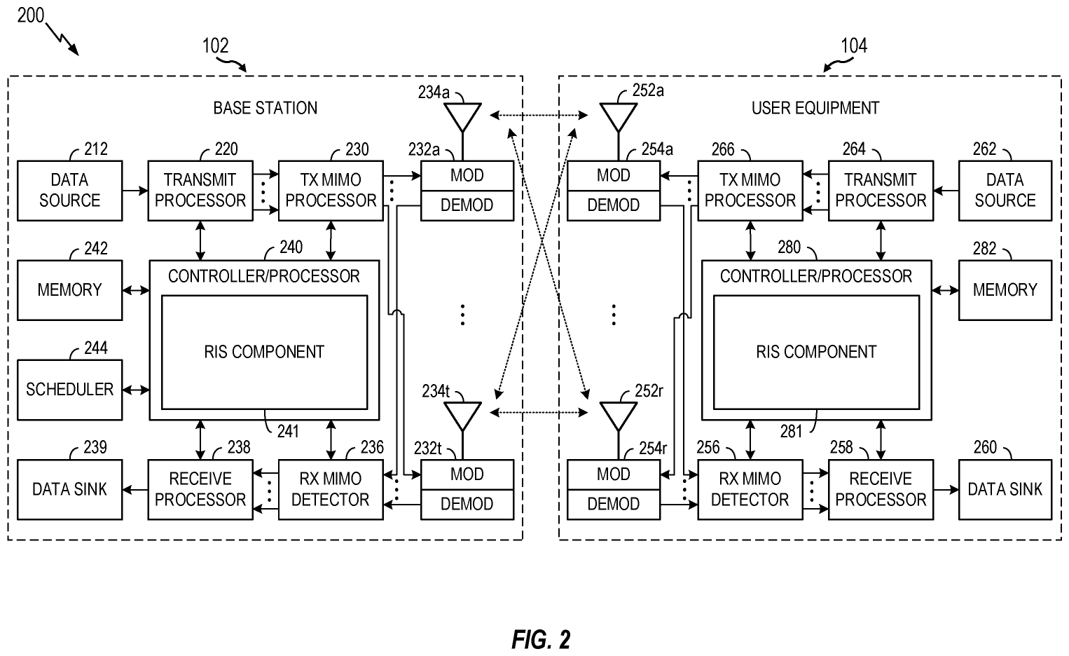

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes RIS component 241, which may be representative of RIS component 199 of FIG. 1. Notably, while depicted as an aspect of controller/processor 240, RIS component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes RIS component 281, which may be representative of RIS component 198 of FIG. 1. Notably, while depicted as an aspect of controller/processor 280, RIS component 281 may be implemented additionally or alternatively in various other aspects of user equipment 104 in other implementations.

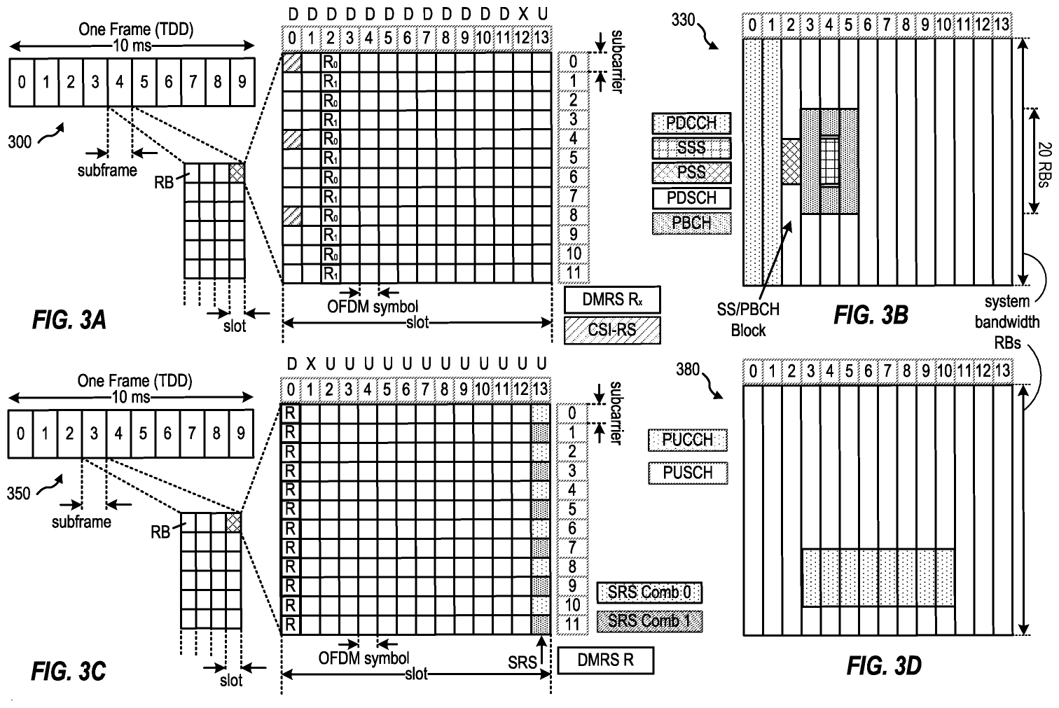

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5G networks may utilize several frequency ranges, which in some cases are defined by a standard, such as the 3GPP standards. For example, 3GPP technical standard TS 38.101 currently defines Frequency Range 1 (FR1) as including 600 MHZ-6 GHZ, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHZ-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range.

### Example Application and Precoding of Reconfigurable Intelligent Surface (RIS)

Massive multiple input multiple output (MIMO) configuration increases throughput. For example, MIMO can achieve high beamforming gain by using active antenna units (AAUs) and can operate with individual radio frequency (RF) chains for each antenna port. Unfortunately, the use of AAUs may significantly increase power consumption.

To further such advantages and extend coverage, RISs may be deployed to reflect impinging waves in desired directions. In some cases, RISs may operate without substantial power consumption when they operate passively to only reflect or refract beams from the transmitter toward the receiver. In some cases, the reflection or refraction direction may be controlled by gNB or a monitoring sidelink UE.

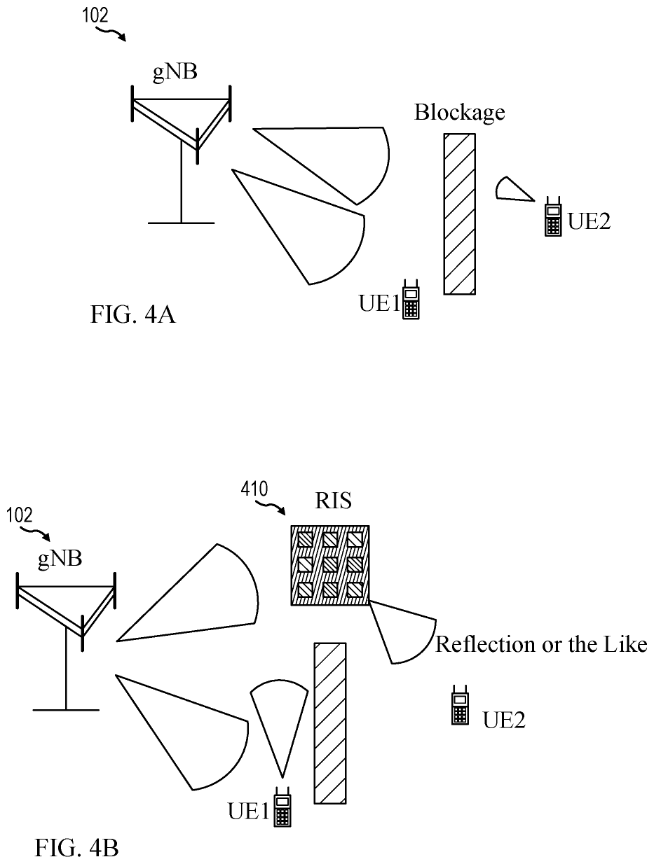

FIG. 4A illustrates an example of communication blockage between wireless communication devices. As shown, impeded by a blockage, a first network entity (a gNB) may only transmit to a first UE (UE1) and may not reach a second UE (UE2), as the blockage preventing signals from reaching UE2. The blockage also prevents UE1 from establishing sidelink communications with UE2. As such, UE2 may not be able to communicate with the gNB or UE1.

FIG. 4B illustrates an example of using a RIS to overcome the blockage, in accordance with certain aspects of the present disclosure. As shown, a RIS may be introduced to reflect or otherwise re-radiate the radio signals to bypass the blockage. For example, communications between the gNB and UE2 may be enabled by the RIS re-radiating one or more beams from the gNB toward UE2 and vice versa. Furthermore, the RIS can also be reconfigured (i.e., directing incoming and outgoing beams at different angles) to enable UE1 and UE2 to establish sidelink communications.

The RIS may perform passive beamforming. For example, the RIS may receive signal power from the transmitter (e.g., the gNB, UE1, and/or UE2) proportional to the number of RIS elements thereon. When the RIS reflects or refracts the radio signal, the RIS elements cause phase shifts to perform conventional beamforming or precoding. The phase shifts are controlled by precoding weights (e.g., a multiplier or an offset of time delay) applied to the RIS elements. For an array of RIS elements, such as an m×n rectangular matrix, for example, a respective precoding weight may be generated or specified for each of the RIS element by a RIS controller.

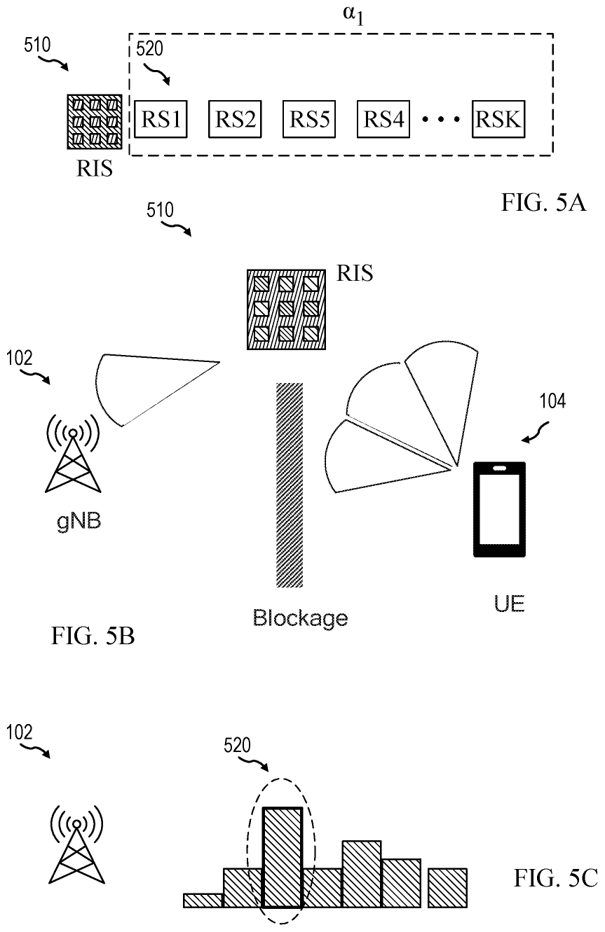

Training for a RIS 510 can be performed using a series of time division multiplexed (TDM'd) reference signals (RS1-RSK) as shown in FIG. 5A. The training RS may be, for example, an SSB, CSI-RS, or tracking reference signal (TRS). The RIS may be configured (e.g., via a RIS controller) to use a different beamforming (BF) codebook for each RS occasion/transmission. In some cases, training may be performed to determine a common phase/coefficient a used across RIS elements (or elements of a sub-RIS). If multiple RISs or sub-RISs are used, the training process may be repeated, for the different RISs or sub-RISs. Various techniques may be used to design the weights and/or beams per RIS. In some cases, such training may result in a combining vector that includes a set of common coefficients (weights/beams), where a common coefficient from the set is used at each RIS component.

In the example illustrated in FIG. 5B, the UE repeat transmitting the RS sequence with different beams, while the gNB measures a receive signal metric, such as spectral efficiency or signal to interference noise ratio (SINR). As shown in FIG. 5C, a winning beam may be declared as the beam corresponding to the highest receive signal metric (520). The gNB may evaluate different receive beams as part of the training, such that the end result is also selection of a transmit/receive beam pair (e.g., a transmit beam of the UE and receive beam of the gNB). Similar training may be performed with the gNB as the transmitter and UE as the receiver.

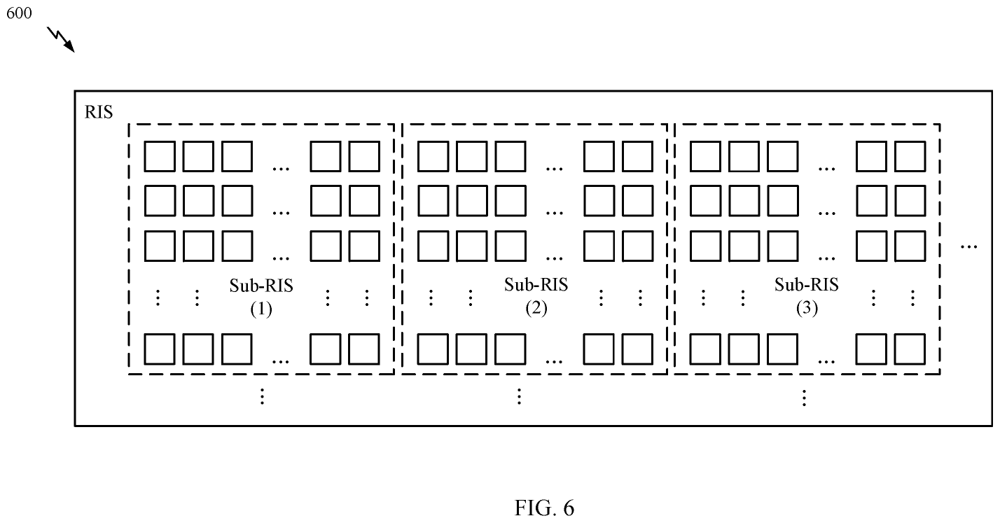

As illustrated in FIG. 6, in some cases, elements of a RIS may be partitioned into groups (or clusters) referred to as sub-RISs. Each sub-RIS may be treated as a separate RIS, with its own weights for precoding its RIS elements. When there is a large number of RIS elements, such cluster-based weight generation may reduce the overall computation workload. For example, the RIS controller may generate, for every small cluster, subset, or part of RIS's elements, such as of a size M₁ by N₁, a weight (digital Fourier transform or DFT) vector. The RIS controller may then apply the same DFT vector generated for the subset across other subsets. The RIS controller may generate varying DFT vectors for the remaining RIS elements according to a pattern, such as by shifting or scaling the DFT vector generated for the initial subset. The RIS controller may also generate different DFT vectors if needed.

The example RIS shown in FIG. 6 has three subsets or Sub-RISs: sub-RIS (1), (2), and (3). The RIS controller may generate a codebook for sub-RIS (1) using any suitable techniques. In some cases, the sub-RIS (2) and sub-RIS (3) may use the same codebook generated for sub-RIS (1). In some cases a combining vector may be based on a PMI codebook. In such cases, the codebook may be configured by a first device (e.g., gNB or UE). In some cases, the codebook may be configured at least partially based on a feedback recommendation from a second device (e.g., a gNB or UE involved in the training with the first device).

In some cases, a single index can be used as a starting DFT index for other clusters to have a shifted version of that index. That is, the DFT weights may be associated with a starting index for generating one or more shifted versions of the DFT weights. The one or more shifted versions of the DFT weights may be applied to other subsets of the RIS elements. For example, if index 4 is used in sub-RIS (1), then index 5 may be used in sub-RIS (2), index 6 may be used in sub-RIS (3), etc. In some cases, repetition of the same index across different sub-RISs or clusters is also possible. In aspects, the all-zero vector(s), if any generated, remains part of the codebook so that RIS controller can disable one or more of the sub-RISs.

### Example Combiners for RIS-Aided Communications

Aspects of the present disclosure provide techniques for configuring RIS components in order to achieve a certain object. For example, RIS components may be configured to combine reflected signals to enhance a received signal at one UE. As an alternative, or in addition, reflected signals may be cancelled out (nulled) to reduce interference at one or more other UEs.

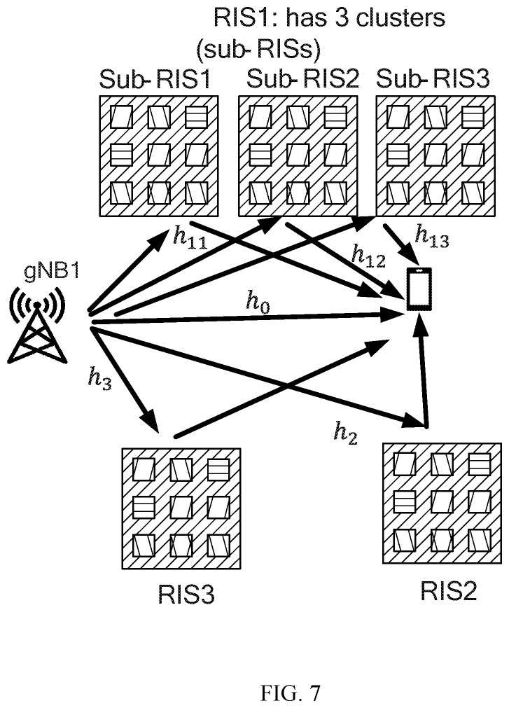

FIG. 7 illustrates how RIS components in a system may result in multiple reflected signals at a UE. The illustrated example shows different paths from a gNB (gNB1) to a UE, via a first RIS, RIS1 (with 3 clusters: Sub-RIS1, Sub-RIS2, and Sub-RIS3), a second RIS, RIS2, and a third RIS, RIS3.

Assume hᵢ denote the equivalent channel vector of size N_{T}×1 where N_{T} is the gNB transmit antennas at resource element (RE) k (or a set of REs within the coherence BW). In the illustrated example, h₀ represents the equivalent channel directly from gNB1 to the UE. h₁₁ represents the equivalent channel from gNB1 reflected off Sub-RIS1 to the UE, h₁₂ represents the equivalent channel from gNB1 reflected off Sub-RIS2 to the UE, while h₁₃ represents the equivalent channel from gNB1 reflected off Sub-RIS3 to the UE. h₂ represents the equivalent channel from gNB1 reflected off RIS2 to the UE, while h₃ represents the equivalent channel from gNB1 reflected off RIS3.

The impact of a RIS on the channel may be represented in a corresponding equivalent channel equation. For example, for Sub-RIS1, the channel (represented as an array of channel coefficients) h₁₁ may be expressed as:

$$h 11 = G 11 \times Phi 11 \times H 11 ,$$

where H11 has size (#elements in subRIS1 and N_Tx); Phi11 is a diagonal matrix with size (#elements in subRIS1 X #elements in subRIS1); and G11 has size (#N_Rx X #elements in subRIS1). G11 may be assumed to include filtering at the UE.

Assuming αᵢⱼ is a common weight (phase/coefficient) vector used across all elements of the jth sub-RIS/cluster of the ith RIS, the received signal at the UE may be represented as:

$${α}_{0} {h}_{0} + {α}_{11} {h}_{11} + {α}_{12} {h}_{12} + {α}_{13} {h}_{13} + {α}_{2} {h}_{2} + {α}_{3} {h}_{3} .$$

If the number of RIS refelctions is equal to size of channel vectors (N_{T}), then the UE (or, more generally, the reference signals Receiver; gNB in the UL and UE in the DL or SL) may be able to control the signals to null or combine or achieve various kinds of combinations, which may be represented as:

$$[ {h}_{0} , {h}_{11} , {h}_{12} , {h}_{13} , {h}_{2} , {h}_{3} ] \cdot [ \begin{matrix}{α}_{0} \\ {α}_{11} \\ {α}_{12} \\ {α}_{13} \\ {α}_{2} \\ {α}_{3}\end{matrix} ] = H * {A}_{α}$$

where H has size N_{T}*#RISs (subRISs).

A_{α} (a combining vector of coefficients to configure the RIS components) can be designed to achieve various objectives. For example, A_{α} can be designed to obtain optimal signal combining (or zero forcing) using singular value decomposition (SVD), by selecting eigenvectors corresponding to highest eigenvalues. In such cases, eigenvectors (columns/precoders/beamformers) may be obtained based on SVD of H*.

If the number of RIS reflections [sub-RISs] is greater than N_{T}, A_{α} can be designed to null interference at a UE, for example, by using SVD and selecting eigenvectors corresponding to zero eigenvalues (or could compute the null space). In such cases, zero forcing may be based on the following equation:

$$[ {h}_{0} , {h}_{11} , {h}_{12} , {h}_{13} , {h}_{2} , {h}_{3} ] \cdot [ \begin{matrix}{α}_{0} \\ {α}_{11} \\ {α}_{12} \\ {α}_{13} \\ {α}_{2} \\ {α}_{3}\end{matrix} ] = H * {A}_{α} = 0 ,$$

which can be solved using any suitable method or using the eigenvectors corresponding to zero eigenvalues (or very small eigenvalues, for example, lower than a threshold) of the matrix H*. Based on this, a UE can perform the SVD or eigenvalues decomposition on H*. If performing SVD, based on the best eigenvalues/vectors (e.g., to maximize the performance such as SINR/rate/throughput), then the UE may select the non-zero eigenvectors corresponding to non-zero eigenvalues (e.g., the best SVD precoder may be considered the non-zero eigenvector corresponding to the maximum eigenvalue of the matrix H*). If performing zero forcing, then the UE can apply SVD on H*, then select the eigenvectors corresponding to zero (or very small eigenvalues may be selected based on a threshold) and one of those vectors may be used.

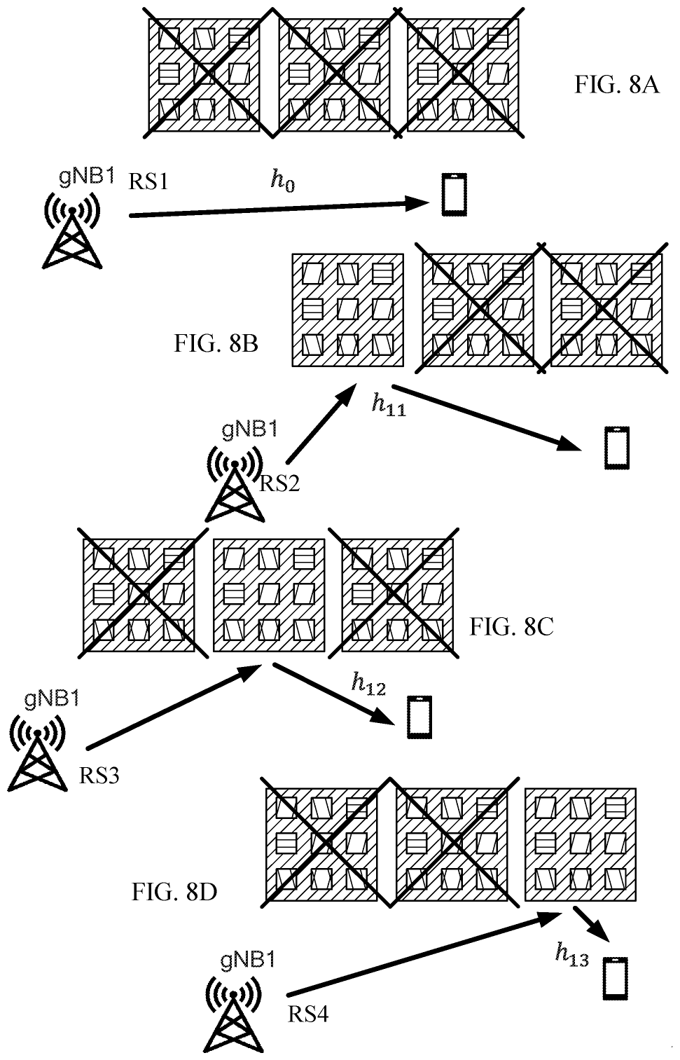

A suitable combining vector A_{α} for such objectives may be determined by performing training procedures involving the RIS elements. For example, FIGS. 8A-8D illustrate an example of how such training may be performed with sub RISs (subRIS1,subRIS2, and subRIS3) of RIS.

A first portion of training may involve training each sub-RIS individually, to obtain the corresponding PHI (diagonal matrix). The gNB may transmit 4 time division multiplexed (TDM'd) reference signals associated with the same spatial beam (e.g., a single SSB/TRS).

As illustrated in FIG. 8A, the gNB transmits a first RS, RS1, directly to the UE, with all of the sub-RISs off, allowing the UE to measure h₀. As illustrated in FIG. 8B, the gNB transmits a second RS, RS2, with only sub-RIS1 turned on, allowing the UE to measure h₁₁. As illustrated in FIG. 8C, the gNB transmits a third RS, RS2, with sub-RIS2 turned on, allowing the UE to measure h₁₂. As illustrated in FIG. 8D, the gNB transmits a fourth RS, RS2, with sub-RIS3 turned on, allowing the UE to measure h₁₃. In some case, the UE may report information regarding these measurements. When all of the subRISs are on, the signal received by the UE may be represented as:

$$[ {h}_{0} , {h}_{11} , {h}_{12} , {h}_{13} ] \cdot [ \begin{matrix}{α}_{0} \\ {α}_{11} \\ {α}_{12} \\ {α}_{13}\end{matrix} ] .$$

Based on these measurements, the gNB can request that the UE computes A_{α}. As an alternative, the gNB could configure some number (e.g., X) of PMIs (e.g., for zero forcing and combiner of different PMIs for different purposes). In such cases, the UE may try those PMIs then decide which PMI is best suited for: 1) a combiner/SVD; or 2) ZF.

In some cases, A_{α} could be generated by a receiver (e.g., a UE or a gNB receiving the RS) which may compute it, quantize it, and send it to all controllers and the gNB. In some cases, A_{α} could be based on a codebook/PMI defined by the gNB and RIS controllers to handle a common weight across all elements (which could be specific per a RIS). If an RIS has a certain capability on refining the coefficient/weight αᵢⱼ, this scenario may be taken into account while computing A_{α}.

In some cases, the UE may signal the PMI or the A_{α} to the gNB. In such cases, the gNB may communicate with the RISs' controllers). In some cases, the UE may signal the PMI or the Aα to the RISs' controllers. In such cases, each RIS's controller may use the common phase αᵢ across all elements.

As noted above, if a RIS's surface has many elements, the surface may be split into multiple sub-RISs. In such cases, a RIS controller can split the RIS's surface into L clusters/sub-RISs where L>=N_TX where N_TX is the number of antennas (or antenna ports) at TX side (gNB or a UE).

One benefit of such clustering or using sub-RIS is that each sub-RIS beamformer/configuration may be well beam trained. In such cases, then the common coefficients may be obtained by the received based on either BF or ZF. This may also help will reduce the time switch (and processing overhead) to change all coefficients, since each sub-RIS is smaller in size and beam optimization is supposed to be simpler.

In some cases, the gNB can configure the UE to compute the PMI (A_{α}) based on a desired object. For example, the UE could compute the PMI based on SVD (e.g., to obtain the best combiners), based on ZF (null space), for interference cancellation, or both. In some cases, the UE may be configured whether to compute the PMI based on SVD, ZF, or both based on radio resource control (RRC), medium access control (MAC) control element (CE), or downlink control information (DCI). In addition, or as an alternative, the UE may be configured via a dedicated physical downlink shared channel (PDSCH), sidelink control information (SCI) or a dedicated physical sidelink shared channel (PSSCH). In this context, dedicated may refer to a PDSCH/PSSCH transmission that is sent for this purpose.

In some cases, A_{α} can be designed based on instantaneous channels (such as worst case or best case channel covariance matrix—eigenvalues based). In other cases, A_{α} can be designed based on an average covariance matrix across all REs.

### Example Methods

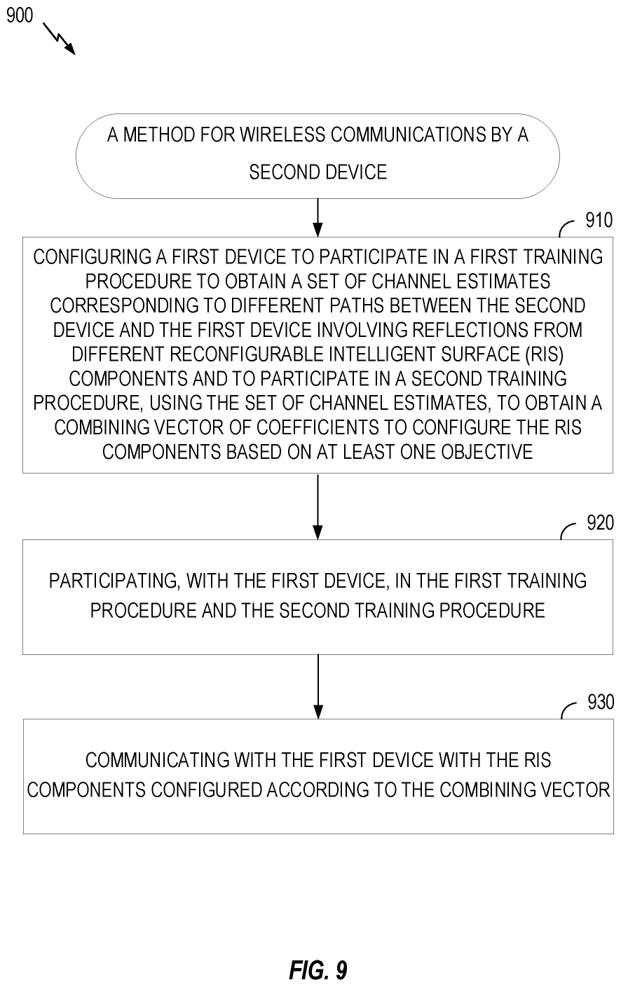

FIG. 9 is a flow diagram illustrating example operations 900 for wireless communication by a second device, in accordance with certain aspects of the present disclosure. The operations 900 may be performed, for example, by a network entity (e.g., such as the BS 102 illustrated in FIGS. 1 and 2) or by a UE (e.g., such as the UE 104 illustrated in FIGS. 1 and 2). The operations 900 may be implemented as software components that are executed and run on one or more processors (e.g., controller/processor 240 of FIG. 2). Further, the transmission and reception of signals by the BS in operations 900 may be enabled, for example, by one or more antennas (e.g., antennas 234 of FIG. 2). In certain aspects, the transmission and/or reception of signals by the UE may be implemented via a bus interface of one or more processors (e.g., controller/processor 240) obtaining and/or outputting signals.

The operations 900 may begin, at a first block 910, by configuring a first device to participate in a first training procedure to obtain a set of channel estimates corresponding to different paths between the second device and the first device involving reflections from different reconfigurable intelligent surface (RIS) components and to participate in a second training procedure, using the set of channel estimates, to obtain a combining vector of coefficients to configure the RIS components based on at least one objective. At 920, the second device participates, with the first device, in the first training procedure and the second training procedure. At 930, the second device communicates with the first device with the RIS components configured according to the combining vector.

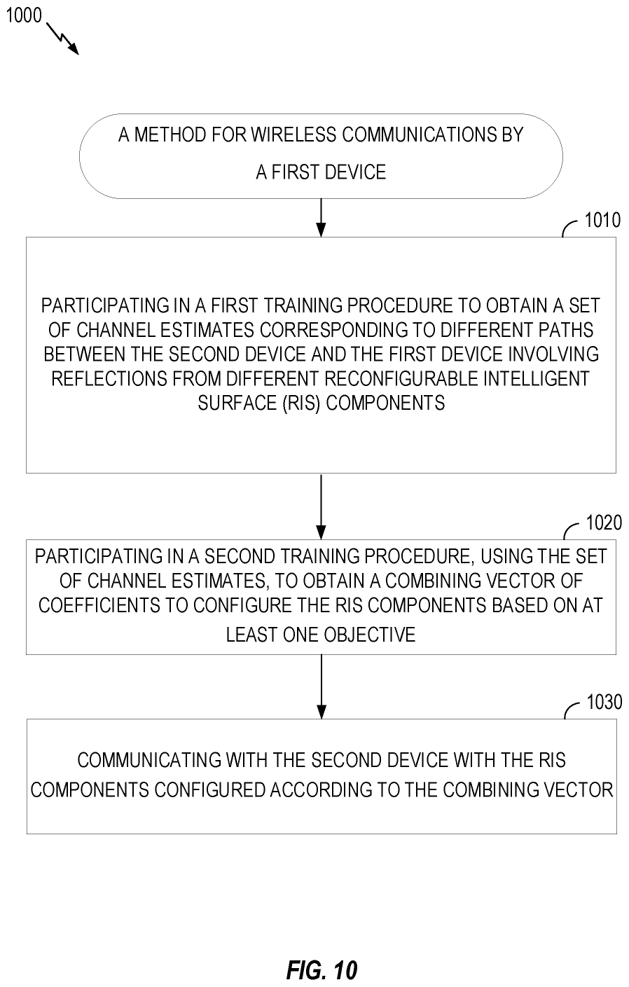

FIG. 10 is a flow diagram illustrating example operations 1000 for wireless communication by a first device, in accordance with certain aspects of the present disclosure. The operations 1000 may be performed, for example, by a UE (e.g., such as the UE 104 illustrated in FIGS. 1 and 2) or base station (such as the base station 102 illustrated in FIGS. 1 and 2). The operations 1000 may be implemented as software components that are executed and run on one or more processors (e.g., controller/processor 280 of FIG. 2). Further, the transmission and reception of signals by the BS in operations 1000 may be enabled, for example, by one or more antennas (e.g., antennas 252 of FIG. 2). In certain aspects, the transmission and/or reception of signals by the BS may be implemented via a bus interface of one or more processors (e.g., controller/processor 280) obtaining and/or outputting signals.

Operations 1000 begin, at 1010, by participating in a first training procedure to obtain a set of channel estimates corresponding to different paths between the second device and the first device involving reflections from different reconfigurable intelligent surface (RIS) components. At 1020, the first device participates in a second training procedure, using the set of channel estimates, to obtain a combining vector of coefficients to configure the RIS components based on at least one objective. At 1030, the first device communicates with the second device with the RIS components configured according to the combining vector.

### Example Wireless Communication Devices

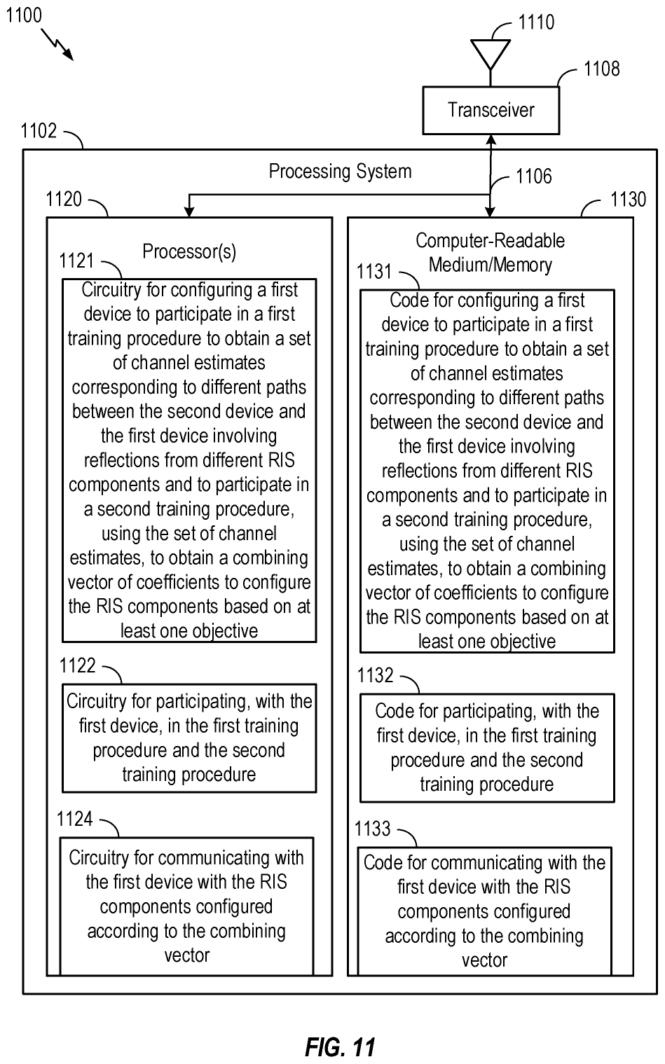

FIG. 11 depicts an example communications device 1100 that includes various components operable, configured, or adapted to perform operations for the techniques disclosed herein, such as the operations depicted and described with respect to FIG. 9. In some examples, communication device 1100 may be a base station 102 or UE 104 as described, for example with respect to FIGS. 1 and 2.

Communications device 1100 includes a processing system 1102 coupled to a transceiver 1108 (e.g., a transmitter and/or a receiver). Transceiver 1108 is configured to transmit (or send) and receive signals for the communications device 1100 via an antenna 1110, such as the various signals as described herein. Processing system 1102 may be configured to perform processing functions for communications device 1100, including processing signals received and/or to be transmitted by communications device 1100.

Processing system 1102 includes one or more processors 1120 coupled to a computer-readable medium/memory 1130 via a bus 1106. In certain aspects, computer-readable medium/memory 1130 is configured to store instructions (e.g., computer-executable code) that when executed by the one or more processors 1120, cause the one or more processors 1120 to perform the operations illustrated in FIG. 9, or other operations for performing the various techniques discussed herein for participate in training of RIS elements.

In the depicted example, computer-readable medium/memory 1130 stores code 1131 for configuring a first device to participate in a first training procedure to obtain a set of channel estimates corresponding to different paths between the second device and the first device involving reflections from different reconfigurable intelligent surface (RIS) components and to participate in a second training procedure, using the set of channel estimates, to obtain a combining vector of coefficients to configure the RIS components based on at least one objective; code 1132 for participating, with the first device, in the first training procedure and the second training procedure; and code 1133 for communicating with the first device with the RIS components configured according to the combining vector.

In the depicted example, the one or more processors 1120 include circuitry configured to implement the code stored in the computer-readable medium/memory 1130, including circuitry 1121 for configuring a first device to participate in a first training procedure to obtain a set of channel estimates corresponding to different paths between the second device and the first device involving reflections from different reconfigurable intelligent surface (RIS) components and to participate in a second training procedure, using the set of channel estimates, to obtain a combining vector of coefficients to configure the RIS components based on at least one objective; circuitry 1122 for participating, with the first device, in the first training procedure and the second training procedure; and circuitry 1124 for communicating with the first device with the RIS components configured according to the combining vector.

Various components of communications device 1100 may provide means for performing the methods described herein, including with respect to FIG. 9.

In some examples, means for transmitting or sending (or means for outputting for transmission) may include the transceivers 232 and/or antenna(s) 234 of the base station 102 illustrated in FIG. 2 and/or transceiver 1108 and antenna 1110 of the communication device 1100 in FIG. 11.

In some examples, means for receiving (or means for obtaining) may include the transceivers 232 and/or antenna(s) 234 of the base station illustrated in FIG. 2 and/or transceiver 1108 and antenna 1110 of the communication device 1100 in FIG. 11.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for receiving and/or obtaining may include various processing system components, such as: the one or more processors 1120 in FIG. 11, or aspects of the base station 102 depicted in FIG. 2, including receive processor 238, transmit processor 220, TX MIMO processor 230, and/or controller/processor 240 (including CSI component 241).

Notably, FIG. 11 is an example, and many other examples and configurations of communication device 1100 are possible.

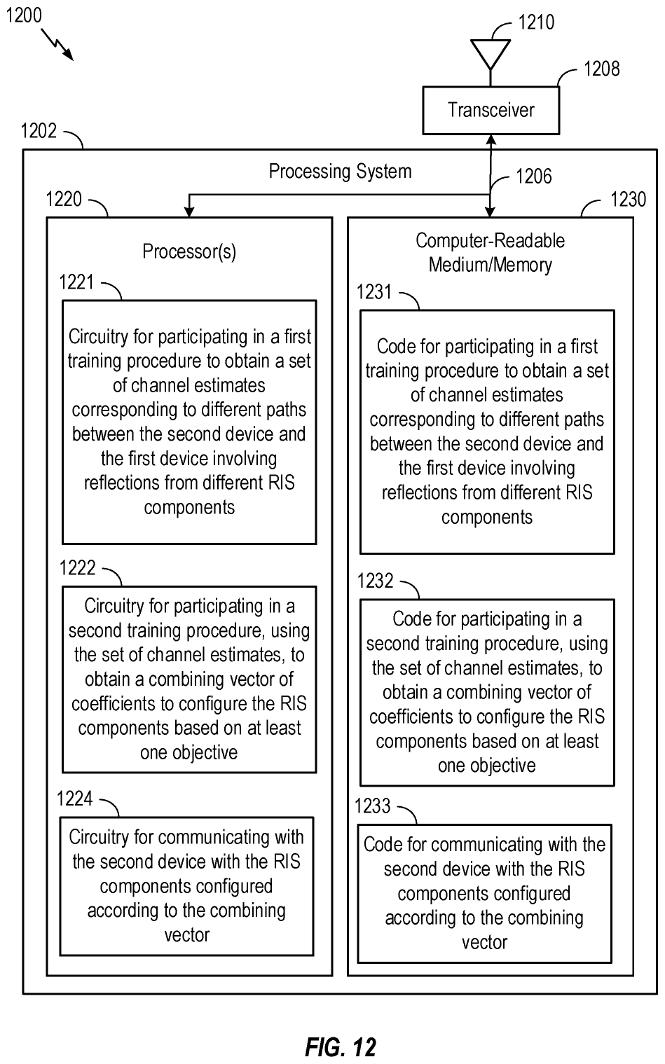

FIG. 12 depicts an example communications device 1200 that includes various components operable, configured, or adapted to perform operations for the techniques disclosed herein, such as the operations depicted and described with respect to FIG. 10. In some examples, communication device 1000 may be a user equipment 104 as described, for example with respect to FIGS. 1 and 2.

Communications device 1200 includes a processing system 1202 coupled to a transceiver 1208 (e.g., a transmitter and/or a receiver). Transceiver 1208 is configured to transmit (or send) and receive signals for the communications device 1200 via an antenna 1210, such as the various signals as described herein. Processing system 1202 may be configured to perform processing functions for communications device 1200, including processing signals received and/or to be transmitted by communications device 1200.

Processing system 1202 includes one or more processors 1220 coupled to a computer-readable medium/memory 1230 via a bus 1206. In certain aspects, computer-readable medium/memory 1230 is configured to store instructions (e.g., computer-executable code) that when executed by the one or more processors 1220, cause the one or more processors 1220 to perform the operations illustrated in FIG. 10, or other operations for performing the various techniques discussed herein for participate in training of RIS elements.

In the depicted example, computer-readable medium/memory 1230 stores code 1231 for participating in a first training procedure to obtain a set of channel estimates corresponding to different paths between the second device and the first device involving reflections from different reconfigurable intelligent surface (RIS) components, code 1232 for participating in a second training procedure, using the set of channel estimates, to obtain a combining vector of coefficients to configure the RIS components based on at least one objective, and code 1233 for communicating with the second device with the RIS components configured according to the combining vector.

In the depicted example, the one or more processors 1220 include circuitry configured to implement the code stored in the computer-readable medium/memory 1230, including circuitry 1221 for participating in a first training procedure to obtain a set of channel estimates corresponding to different paths between the second device and the first device involving reflections from different reconfigurable intelligent surface (RIS) components; circuitry 1222 for participating in a second training procedure, using the set of channel estimates, to obtain a combining vector of coefficients to configure the RIS components based on at least one objective; and circuitry 1224 for communicating with the second device with the RIS components configured according to the combining vector.

Various components of communications device 1200 may provide means for performing the methods described herein, including with respect to FIG. 9.

In some examples, means for transmitting or sending (or means for outputting for transmission) may include the transceivers 254 and/or antenna(s) 252 of the user equipment 104 illustrated in FIG. 2 and/or transceiver 1208 and antenna 1210 of the communication device 1200 in FIG. 12.

In some examples, means for receiving (or means for obtaining) may include the transceivers 254 and/or antenna(s) 252 of the user equipment 104 illustrated in FIG. 2 and/or transceiver 1208 and antenna 1210 of the communication device 1200 in FIG. 12.

In some examples, means for generating and/or means for transmitting may include various processing system components, such as: the one or more processors 1220 in FIG. 12, or aspects of the user equipment 104 depicted in FIG. 2, including receive processor 258, transmit processor 264, TX MIMO processor 266, and/or controller/processor 280 (including CSI Component 281).

Notably, FIG. 12 is an example, and many other examples and configurations of communication device 1200 are possible.

### Example Clauses

Implementation examples are described in the following numbered clauses:

Clause 1: A method for wireless communications by a first device, comprising: participating in a first training procedure to obtain a set of channel estimates corresponding to different paths between a second device and the first device involving reflections from different reconfigurable intelligent surface (RIS) components; participating in a second training procedure, using the set of channel estimates, to obtain a combining vector of coefficients to configure the RIS components based on at least one objective; and communicating with the second device with the RIS components configured according to the combining vector.

Clause 2: The method of Clause 1, wherein: the first device comprises a user equipment (UE) and the second device comprises a base station; the first device comprises a base station and the second device comprises a UE; or the first device comprises a UE and the second device comprises a UE.

Clause 3: The method of any one of Clauses 1-2, wherein the at least one objective is to combine signals reflected by the RIS components to enhance a received signal at the first device.

Clause 4: The method of Clause 3, wherein the combining vector is obtained using single value decomposition to select eigenvectors corresponding to highest eigenvalues.

Clause 5: The method of any one of Clauses 1-4, wherein the at least one objective is to cancel signals reflected by the RIS components to null interference at one or more other devices.

Clause 6: The method of Clause 5, wherein the combining vector is obtained using single value decomposition to select eigenvectors corresponding to zero eigenvalues.

Clause 7: The method of any one of Clauses 1-6, wherein the combining vector comprises a set of common coefficients, wherein a common coefficient from the set is used at each RIS component.

Clause 8: The method of Clause 7, wherein the RIS components comprise one or more individual RISs and one or more clusters of RISs.

Clause 9: The method of Clause 8, wherein the set of common coefficients includes common coefficients used across all elements of different RISs of a RIS cluster.

Clause 10: The method of any one of Clauses 1-9, wherein participating in a first training procedure comprises: performing first channel measurement based on a first reference signal received while all of the RIS components are disabled; and performing one or more other channel measurements based on one or more reference signals received while only one RIS component is enabled.

Clause 11: The method of Clause 10, wherein the first device computes the combining vector based on the first channel measurement and other channel measurements.

Clause 12: The method of any one of Clauses 1-11, wherein the first device computes the combining vector, quantizes values of the combining vector, and transmits the quantized values to at least one of RIS controllers or the second device.

Clause 13: The method of any one of Clauses 1-12, wherein: the combining vector is based on a precoding matrix indicator (PMI) codebook; and the codebook is configured by the first device or the codebook is configured at least partially based on a feedback recommendation from the second device.

Clause 14: The method of any one of Clauses 1-13, wherein the RIS components comprise portions of a RIS surface split into sub-RISs.

Clause 15: The method of any one of Clauses 1-14, further comprising receiving signaling indicating the at least one objective on which the combining vector is based.

Clause 16: The method of Clause 15, wherein the signaling comprises at least one of radio resource control (RRC), medium access control (MAC) control element (CE), or downlink control information (DCI) signaling a physical downlink shared channel (PDSCH), sidelink control information (SCI), or a physical sidelink shared channel (PSSCH).

Clause 17: A method for wireless communications by a second device, comprising: configuring a first device to participate in a first training procedure to obtain a set of channel estimates corresponding to different paths between a second device and the first device involving reflections from different reconfigurable intelligent surface (RIS) components and to participate in a second training procedure, using the set of channel estimates, to obtain a combining vector of coefficients to configure the RIS components based on at least one objective; participating, with the first device, in the first training procedure and the second training procedure; and communicating with the first device with the RIS components configured according to the combining vector.

Clause 18: The method of Clause 17, wherein the participating comprises: receiving, from the first device, information regarding the combining vector of coefficients; and communicating with one or more RIS controllers to configure the RIS components according to the information.

Clause 19: The method of any one of Clauses 17-18, wherein the participating comprises asking the first device to compute the combining vector.

Clause 20: The method of any one of Clauses 17-19, wherein the second device configures a number of precoding matrix indicators (PMIs) and receives, from the first device, an indication of one of the number of PMIs.

Clause 21: An apparatus, comprising: a memory and at least one processor coupled with the memory, wherein the memory includes instructions executable by the at least one processor to cause the apparatus to perform a method in accordance with any one of Clauses 1-20.

Clause 22: An apparatus, comprising means for performing a method in accordance with any one of Clauses 1-20.

Clause 23: A non-transitory computer-readable medium comprising executable instructions that, when executed by one or more processors of an apparatus, cause the apparatus to perform a method in accordance with any one of Clauses 1-20.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of beam refinement procedures in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a first device, comprising:
participating in a first training procedure to obtain a set of channel estimates corresponding to different paths between a second device and the first device involving reflections from different reconfigurable intelligent surface (RIS) components;
participating in a second training procedure, using the set of channel estimates, to obtain a combining vector of coefficients to configure the RIS components based on at least one objective; and
communicating with the second device with the RIS components configured according to the combining vector.

2. The method of claim 1, wherein:
the first device comprises a user equipment (UE) and the second device comprises a base station;
the first device comprises a base station and the second device comprises a UE; or
the first device comprises a UE and the second device comprises a UE.

3. The method of claim 1, wherein the at least one objective is to combine signals reflected by the RIS components to enhance a received signal at the first device.

4. The method of claim 3, wherein the combining vector is obtained using single value decomposition to select eigenvectors corresponding to highest eigenvalues.

5. The method of claim 1, wherein the at least one objective is to cancel signals reflected by the RIS components to null interference at one or more other devices.

6. The method of claim 5, wherein the combining vector is obtained using single value decomposition to select eigenvectors corresponding to zero eigenvalues.

7. The method of claim 1, wherein the combining vector comprises a set of common coefficients, wherein a common coefficient from the set is used at each RIS component.

8. The method of claim 7, wherein the RIS components comprise one or more individual RISs and one or more clusters of RISs.

9. The method of claim 8, wherein the set of common coefficients includes common coefficients used across all elements of different RISs of a RIS cluster.

10. The method of claim 1, wherein participating in a first training procedure comprises:
performing first channel measurement based on a first reference signal received while all of the RIS components are disabled; and
performing one or more other channel measurements based on one or more reference signals received while only one RIS component is enabled.

11. The method of claim 10, wherein the first device computes the combining vector based on the first channel measurement and other channel measurements.

12. The method of claim 1, wherein the first device computes the combining vector, quantizes values of the combining vector, and transmits the quantized values to at least one of RIS controllers or the second device.

13. The method of claim 1, wherein:
the combining vector is based on a precoding matrix indicator (PMI) codebook; and
the codebook is configured by the first device or the codebook is configured at least partially based on a feedback recommendation from the second device.

14. The method of claim 1, wherein the RIS components comprise portions of a RIS surface split into sub-RISs.

15. The method of claim 1, further comprising receiving signaling indicating the at least one objective on which the combining vector is based.

16. The method of claim 15, wherein the signaling comprises at least one of radio resource control (RRC), medium access control (MAC) control element (CE), or downlink control information (DCI) signaling a physical downlink shared channel (PDSCH), sidelink control information (SCI), or a physical sidelink shared channel (PSSCH).

17. A method for wireless communications by a second device, comprising:
configuring a first device to participate in a first training procedure to obtain a set of channel estimates corresponding to different paths between a second device and the first device involving reflections from different reconfigurable intelligent surface (RIS) components and to participate in a second training procedure, using the set of channel estimates, to obtain a combining vector of coefficients to configure the RIS components based on at least one objective;
participating, with the first device, in the first training procedure and the second training procedure; and
communicating with the first device with the RIS components configured according to the combining vector.

18. The method of claim 17, wherein the participating comprises:
receiving, from the first device, information regarding the combining vector of coefficients; and
communicating with one or more RIS controllers to configure the RIS components according to the information.

19. The method of claim 17, wherein the participating comprises asking the first device to compute the combining vector.

20. The method of claim 17, wherein the second device configures a number of precoding matrix indicators (PMIs) and receives, from the first device, an indication of one of the number of PMIs.

21. An apparatus for wireless communications by a first device, comprising:
a memory; and
at least one processor coupled with the memory, wherein the memory includes instructions executable by the at least one processor to cause the first device to
participate in a first training procedure to obtain a set of channel estimates corresponding to different paths between a second device and the first device involving reflections from different reconfigurable intelligent surface (RIS) components;
participate in a second training procedure, using the set of channel estimates, to obtain a combining vector of coefficients to configure the RIS components based on at least one objective; and
communicate with the second device with the RIS components configured according to the combining vector.

22. The apparatus of claim 21, wherein:
the first device comprises a user equipment (UE) and the second device comprises a base station;
the first device comprises a base station and the second device comprises a UE; or
the first device comprises a UE and the second device comprises a UE.

23. The apparatus of claim 21, wherein the at least one objective is to combine signals reflected by the RIS components to enhance a received signal at the first device.

24. The apparatus of claim 23, wherein the combining vector is obtained using single value decomposition to select eigenvectors corresponding to highest eigenvalues.

25. The apparatus of claim 21, wherein the at least one objective is to cancel signals reflected by the RIS components to null interference at one or more other devices.

26. The apparatus of claim 25, wherein the combining vector is obtained using single value decomposition to select eigenvectors corresponding to zero eigenvalues.

27. The apparatus of claim 21, wherein the combining vector comprises a set of common coefficients, wherein a common coefficient from the set is used at each RIS component.

28. The apparatus of claim 21, wherein the at least one processor and the memory are configured to:
perform first channel measurement based on a first reference signal received while all of the RIS components are disabled; and
perform one or more other channel measurements based on one or more reference signals received while only one RIS component is enabled.

29. The apparatus of claim 21, wherein the at least one processor and memory are further configured to receive signaling indicating the at least one objective on which the combining vector is based.

30. An apparatus for wireless communications by a second device, comprising:
a memory; and
at least one processor coupled with the memory, wherein the memory includes instructions executable by the at least one processor to cause the second device to
configure a first device to participate in a first training procedure to obtain a set of channel estimates corresponding to different paths between a second device and the first device involving reflections from different reconfigurable intelligent surface (RIS) components and to participate in a second training procedure, using the set of channel estimates, to obtain a combining vector of coefficients to configure the RIS components based on at least one objective;
participate, with the first device, in the first training procedure and the second training procedure; and
communicate with the first device with the RIS components configured according to the combining vector.
